(19) United States
(12) Patent Application Publication
(10) Pub. No.: US 2002/0156552 A1
(43) Pub. Date: Oct. 24, 2002

(54) System and method for media file statistics and reporting

(76) Inventor: Jon Whiting, Norwalk, CT (US)

Correspondence Address: Basam E. Nabulsi, Esq., e-Media, LLC, 199 Elm Street, New Canaan, CT, 06840, US

(21) Appl. No.: 09/782,111

(22) Filed: Feb. 13, 2001

(51) Int. Cl. G06F 7/00

(52) U.S. Cl. 700/300

(57) ABSTRACT

A system and method for collecting useful streaming media statistics into a database and providing reporting capabilities with respect to the collected streaming media statistics are provided. The system/method advantageously provides a searchable database from which reports may be generated from the data collected in the database. According to present disclosure, a method/system for generating reports related to media file delivery is provided in which data is collected by media server(s) in textual log files in media player format, transferred to a statistics server on a predetermined periodic basis, and input to a database. The data is generally input to predetermined tabular fields based on characteristics of the data, and is searchable based thereon. A user interface is also provided that allows a user to generate reports based on selected criteria that are displayed on the user interface.

### BACKGROUND OF THE DISCLOSURE

1. Technical Field

The present disclosure relates to a system and method for collecting useful media file statistics, and providing reporting and analytic capabilities with respect to the collected media statistics. More particularly, the present disclosure relates to a system/method for collecting textual log file data related to live streaming and on-demand media delivery in a searchable database from which reports may be generated and analysis performed.

2. Background of Related Art

The ubiquitous nature of the World Wide Web has prompted significant attention to analysis of Web traffic, conversion rates and related performance issues. To address this analytical need, software has been developed to facilitate tracking of Web traffic and reporting/analysis based thereon. Web traffic analysis software is generally intended to provide useful information about visitor interaction with a Website and associated Website performance, thereby allowing business decisions to be made that will ideally maximize financial return and/or performance of a Website.

Two software categories have been developed to track and analyze what is happening on Websites: web log analysis tools and Web mining tools. Web log analysis tools collect data from Website log files that are created by Web and proxy servers. The creation of log files is generally determined by server configuration, and Web log analysis tools generally read the log files, distilling data for use in reporting/analysis. Web mining represents a form of traffic analysis. In Web mining, Web traffic information is generally integrated with data available in other databases.

Generally, a server creates a log file to record the results of an exchange or interchange between a computer making a request and the responding computer. A typical log file is a text file that may contain information such as the IP address of the computer making the request, the name of the requested file, the date/time of the request, the browser type, the referring site or page, the destination site, etc. Depending on the number of requests, it is not uncommon for log files to grow to hundreds of megabytes of information per day.

Several commercially available software products have been developed that attempt to address the need for reliable Web traffic measurement and analysis tools. One such commercially available product—Hit List—is available from Accrue Software, Inc. (Fremont, Calif.) (formerly available from Marketwave Corporation; Seattle, Wash.). The Hit List product offers “near real time” data related to Website traffic information that may be cross-referenced with an enterprise's legacy demographic and transaction data. The Hit List product collects and updates databases with Web traffic data, and provides functionality that allows a user to combine Web data with multiple enterprise data sources, such as transaction or demographic information, into a single report.

The Hit List product creates a Web traffic database to store all Web server activity information. Reports may then be generated from the data contained in the database, which is generally available for additional queries and/or linking to other data within the organization. Hit List provides standard built-in reports that are organized into folders accessible from the main screen. To utilize a built-in report, the user may click on a “Design” button and click the “Show Toolbox.” The Hit List product will then list the built-in sections, tables and graphs, permitting a user to drag and drop any of them into a report. Hit List permits report production in Microsoft Word, HTML, ASCII, CSV and e-mail formats. The Hit List product also permits remote reporting accessible over the Internet using HitList Remote Reporting functionality.

A second source of commercial statistics and reporting tools is WebTrends Corporation (Portland, Oreg.). WebTrends offers a range of Web traffic and reporting tools, including CommereTrends, WebTrends Enterprise Reporting Server, WebTrends Live and WebTrends Enterprise Suite. Generally, in the realm of Web site statistics and reporting, the WebTrends products offer similar functionality to that available with the Hit List product. In addition, the WebTrends server suite currently offers streaming media technical analysis, providing users the ability to access reports related to clip popularity, packets transferred, player popularity (e.g., Windows Media Player and RealNetworks Player), browser popularity, transfer speeds, top users, and the like. Other statistics and reporting tools are available from Lariat Software (Seattle, Wash.; Lariat MediaReports product) and Microsoft Corporation (Seattle, Wash.; Windows Media SDK).

Despite the Web statistics and reporting tool developments to date, including the commercial products described hereinabove, a need remains for a statistics/reporting tool operative with media delivery, e.g., video and/or audio streaming, that provides increased user flexibility in analyzing data and/or generating reports. In addition, a need remains for a statistics/reporting tool operative with media delivery that provides an enhanced user friendly interface. These and other objects are achieved according to the system/method disclosed herein, as will be apparent from the detailed description that follows.

### SUMMARY OF THE DISCLOSURE

A system and method for collecting useful media file statistics into a database and providing reporting and analytic capabilities with respect to the collected media file statistics are provided. The system/method advantageously provides a searchable database from which reports may be generated from the media file delivery data collected in the database, providing enhanced flexibility to the user/analyst and allowing improved analysis and/or business decision-making based on the data contained therein.

According to present disclosure, a method/system for generating reports related to media file delivery is provided. The method/system involves collecting data in media server(s) that are delivering the media files to users upon request. The media server employed according to the present disclosure may be included within a redundant array of media servers. The data is collected in textual log files in media server format. The textual log files may advantageously collect data related to IP address of a computer making a media file request, a name of said requested file, user name, date of said request, browser type, referring Website, destination Website, media server name, media server IP address, error code, bytes received, bytes sent, time taken, and the like.

The system/method further involves transferring the textual log files containing the collected data from the media server to a statistics server on a predetermined periodic basis, e.g., every six hours, every twelve hours, or once per day. The transferred data contained in the log files is input data into a database. The data is generally input to the database in individual directories. Moreover, the data may be advantageously stored in predetermined tabular fields based on characteristics of the data. For example, the predetermined tabular fields within the database may be segregated by the names of the individual clients using the disclosed method/system.

A user interface is also provided according to the present disclosure. The user interface allows a user to generate reports based on selected criteria that are displayed on the user interface. The selected criteria generally correspond to the criteria used in assigning/inputting the data from the log files to the predetermined tabular fields. The user interface is generally accessible to users based upon a user name and password validation process. In a preferred embodiment, the user name and password validation process defines multiple tiers of access clearance to data stored within the database.

According to the present disclosure, the user interface generally includes a listing of pre-designed reports. The user interface also generally includes screen displays that permit users to define date ranges for report generation, as well as permitting users to define specific data types for report generation. For example, the specific data types may be selected from among such categories as streams, media player, server, client name, time period, bandwidth and the like.

Further features, aspects and functions of the method/system of the present disclosure will become apparent from the detailed description and accompanying figures which follow.

### BRIEF DESCRIPTION OF THE FIGURES

So that those having ordinary skill in the art to which the disclosed system and method appertains will more readily understand how to employ and use the same, reference may be made to the drawings and accompanying detailed description in which like reference numbers designate the same or similar structures, wherein:

FIG. 1 is a flowchart depicting data flow according to the system and method of the present disclosure;

FIG. 2 is a screen shot of a user interface according to the system/method of the present disclosure;

FIG. 3 is a screen shot of an alternative user interface according to the system/method of the present disclosure;

FIG. 4 is a screen shot of an alternative user interface according to the system/method of the present disclosure;

FIG. 5 is a screen shot of an alternative user interface according to the system/method of the present disclosure;

FIG. 6 is a screen shot of an alternative user interface according to the system/method of the present disclosure;

FIG. 7 is a screen shot of an alternative user interface according to the system/method of the present disclosure;

FIG. 8 is a screen shot of an alternative user interface according to the system/method of the present disclosure;

FIG. 9 is a screen shot of an alternative user interface according to the system/method of the present disclosure;

FIG. 10 is a screen shot of an alternative user interface according to the system/method of the present disclosure;

FIG. 11 is a screen shot of an alternative user interface according to the system/method of the present disclosure; and

FIG. 12 is a screen shot of an alternative user interface according to the system/method of the present disclosure.

### DETAILED DESCRIPTION OF PREFERRED EMBODIMENT(S)

A system and method for collecting useful media file statistics into a database and providing reporting and analytic capabilities with respect to the collected media file delivery statistics are provided. The system/method advantageously provides a searchable database from which reports may be generated from the data collected in the database, providing enhanced flexibility to the user/analyst and allowing improved analysis and/or business decision-making based on the data contained therein.

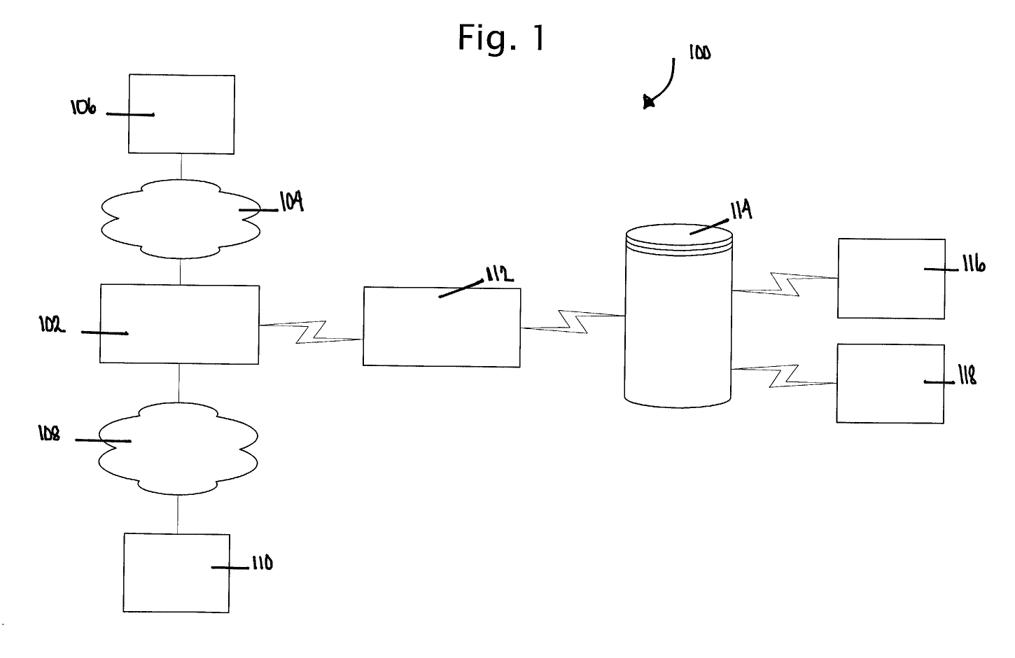

Turning to FIG. 1, a schematic depiction of data flow according to a media delivery system 100 according to the present disclosure is provided. System 100 includes media server 102 that communicates via computer network 104, e.g., the Internet and/or the World Wide Web, with a user 106, and through a further computer network 108, e.g., a LAN and/or WAN intranet, with user 110. As will be readily apparent, users 106 and 110 are representative of entire classes of users that may access media server 102 via computer networks 104, 108. According to the present disclosure, media server 102 is advantageously included within a network communication system of the type disclosed in co-pending and commonly assigned application, “Flat Network Communication System,” Ser. No. 09/535,422, the contents of which are hereby incorporated by reference. Thus, for example, media server 102 may advantageously constitute a media server from among a redundant array of media servers (RAMS), as are known in the art.

Users 106, 110 may request a media file, e.g., a video and/or audio file, from media server 102. Users 106, 110 generally request the media file using their Web browser, e.g., Netscape or Microsoft's Internet Explorer, by clicking on a media file link. Media file links appear on many Web pages, and the number of Web pages including media file links continues to grow rapidly as broadband connectivity increases and as content owners make available greater numbers of media assets on computer networks. In system 100 of FIG. 1, users 106, 110 are directed/redirected to media server 102 to receive the desired media file.

The media file to be delivered to users 106, 110 may constitute a stored media file, i.e., a video-on-demand (“VOD”) file, or a “live” media file, i.e., a media file that is substantially simultaneously being created, encoded and fed to media server 102 through conventionally available means. In addition, the requested media file may be delivered with associated content, e.g., HTML pages, PowerPoint slides, word processing documents, and the like, as disclosed in co-pending, commonly assigned provisional patent application, “Video Enhanced Electronic Commerce Systems and Methods,” Serial No. 60/211,310, the contents of which are hereby incorporated by reference. Thus, according to the present disclosure it is contemplated that system 100 is adapted to deliver any media file stored on and/or processed by media server 102 to users 106, 110.

According to system 100 of the present disclosure, textual log files in media player format are generated by media server 102 in connection with delivery of media file(s) to users 106, 110. The textual log files include conventional information concerning and/or related to media file delivery, e.g., requesting IP address, username, date and time of request, server name, computer name, server IP address, requested file name, error code, bytes received, bytes sent, time taken, browser, referring page, etc. Textual log files according to system 100 may be created according to any standard protocol, e.g., industry standards known as NCSA, W3C, Microsoft IIS format and O'Reilly WebSite format.

According to the present disclosure, a statistics server 112 communicates with media server 102 to facilitate, inter alia., transfer of textual log files from media server 102 to statistics server 112. Media server 102 and statistics server 112 maybe geographically co-located, e.g., in a data center, an appliance or other physical location having connectivity to network 104 and/or network 108. Although ongoing real time transfer of log files from media server 102 to statistics server 112, log files are generally communicated from media server 102 to statistics server 112 on a periodic predetermined batch basis, e.g., once every six hours, every twelve hours or every twenty four hours. In a preferred embodiment of system 100, textual log files are communicated from media server 102 to statistics server 112 by FTP transfer once or twice per day. It is further contemplated that a plurality of statistics servers may be provided in parallel, e.g., a redundant array of statistics servers, to facilitate handling of high log file load and to provide failsafe backup.

Statistics server 112 reads the information contained within log files transferred from media server 102 and stores the information in database 114. Preferably, database 114 includes a series of directories that facilitate segregation of and access to information within database 114. Thus, for example, directories may be established based on the client/entity that placed particular media files on, or processed particular media files through, media server 102. Directories may also be established within database 114 based on other criteria, e.g., media player format associated with individual media files, geographic location of users, and the like.

Statistics server 112 advantageously directs individual pieces of information to predetermined tabular fields, e.g., fields that correlate to the information concerning and/or related to media file delivery contained within the log files. The tabular fields established within database 114 according to system 100 may be segregated by client, division, or any other relevant criteria for the subject media files. Additional data/information is added to respective tabular fields within database 114 on a periodic basis, as additional log files are transferred from media server 102.

With further reference to FIG. 1, analysts 116, 118 may communicate with database 114 to access the data/information stored therewithin. As with users 106, 110, analysts 116, 118 are representative of entire classes of analysts that may access database 114 in accordance with the present disclosure. As used herein, an analyst is an individual and/or an entity having a connection to and/or an interest in delivery of media files by system 100. Thus, analysts 116, 118 may have rights in the media files delivered by media server 102, may have a relationship to the network that includes media server 102, and/or may have acquired access to the data/information contained in database 116, e.g., based on a subscription or other grant of permission.

Analysts 116, 118 access database 116 through conventional network communication systems, e.g., based upon a LAN, WAN or across an extended computer network, e.g., the Internet or the World Wide Web. In preferred embodiments of system 100 according to the present disclosure, access to database 116 is protected by a conventional username/password regimen. In addition, tiered levels of access to data/information within database 116 are typically provided, thereby limiting data/information access to appropriate individuals. For example, based on the segregation of data within database 116, individuals/analysts associated with Company X may advantageously be restricted to accessing data/information concerning delivery of Company X's media files. However, individuals/analysts responsible for administering the entirety of system 100 and/or the network that includes system 100 may have access to the entirety of database 116.

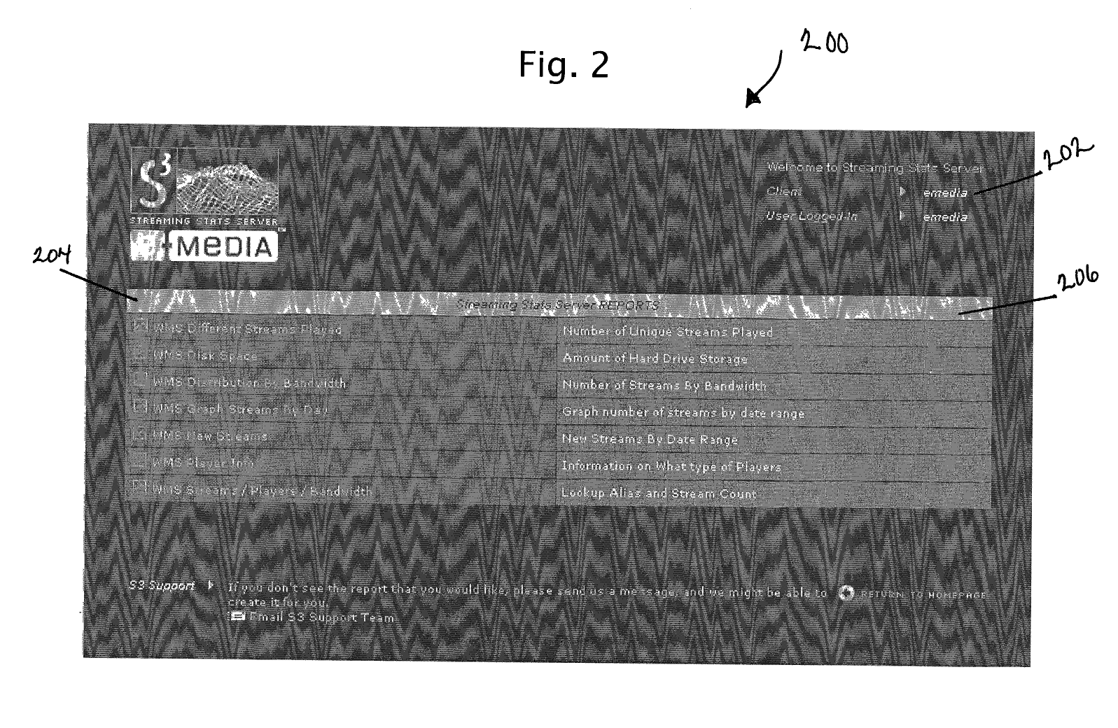

System 100 advantageously provides analysts with a user-friendly and highly efficient user interface that facilitates effective, flexible generation of reports and data analysis. With reference to FIG. 2, an exemplary initial user interface 200 according to the present disclosure is depicted. Of note, in the exemplary screen shot for user interface 200, analyst 202, i.e., the analyst that has signed on to the system, is emedia (both “client” and “user logged-in”). Exemplary initial user interface 200 provides an analyst, e.g., analyst “emedia,” access to a variety of pre-designed reports based on the data contained in database 116. Thus, in the tabular presentation of user interface 200, left column 204 contains a series of reporting criteria for use in parsing the data contained in database 114. In the corresponding right column 206, user interface 200 provides a brief description of the parsing criteria contained in left column 204.

Thus, for example, the first listed parsing criteria in left column 204 is “Real Different Streams Played” which corresponds to “Number of Unique Streams Played” in the RealMedia format in right column 206. Similarly, the bottom-most parsing criteria in left column 204 is “WMS Streams By Time Of Day” which corresponds to “Streams ending within a time frame” in right column 206. An individual/analyst may select a desired parsing criteria by clicking on the desired entry in left column 204. In response to an analyst's selection of a pre-designed report, the system/method of the present disclosure automatically accesses the formatting of the selected report, extracts the required information from database 116, and displays the desired report on the analyst's monitor.

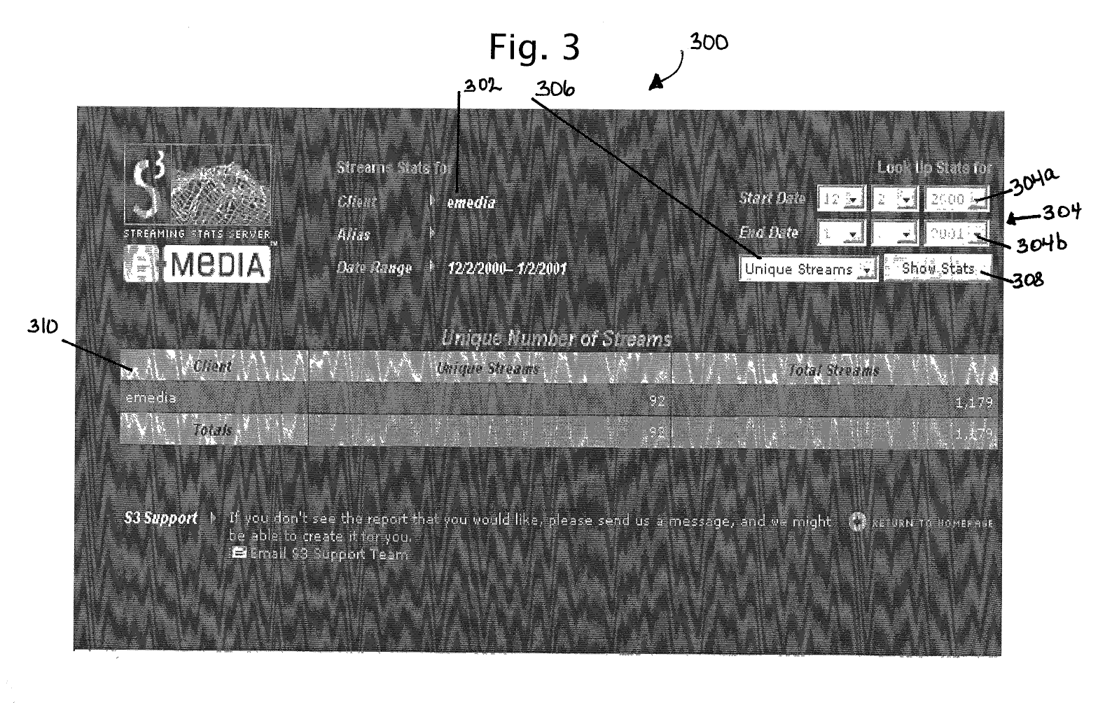

Turning to FIG. 3, a further screen shot is provided in which user interface 300 according to a system/method of the present disclosure is provided. Block 302 of user interface 300 sets forth the client utilizing the system/method of the present disclosure, in this case “emedia.” With reference to the upper right hand comer of screen shot 300, search criteria 304 are provided. Search criteria 304 provide individuals/analysts with tremendous power and flexibility in generating reports and performing analysis based on the data/information contained within database 116. Thus, lines 304a and 304b allow the individual/analyst to define the date range for the report/analysis of interest. In the screen shot of FIG. 3, lines 304a, 304b have defined the date range as Dec. 2, 2000 through Jan. 2, 2001, i.e., a one month period, on user interface 300. The selected date range is reflected in block 302.

Drop down menu 306 allows the individual/analyst to identify the information/data of interest for purposes of reporting/analysis according to the system/method of the present disclosure. Thus, in screen shot 300, the individual/analyst has selected “Unique Streams” in menu 306. The “Show Stats” search command 308 transmits the requested date range (lines 304a, 304b) and the selected information/data (menu 306) to database 116, retrieving the requested information/data for the requested date range. In the screen shot of FIG. 3, search command 308 has already been triggered and the information/data retrieved. Thus, as shown in table 310, for client “emedia,” a total of 92 unique streams were delivered during the requested one month time frame, and a total of 1,137 streams were delivered.

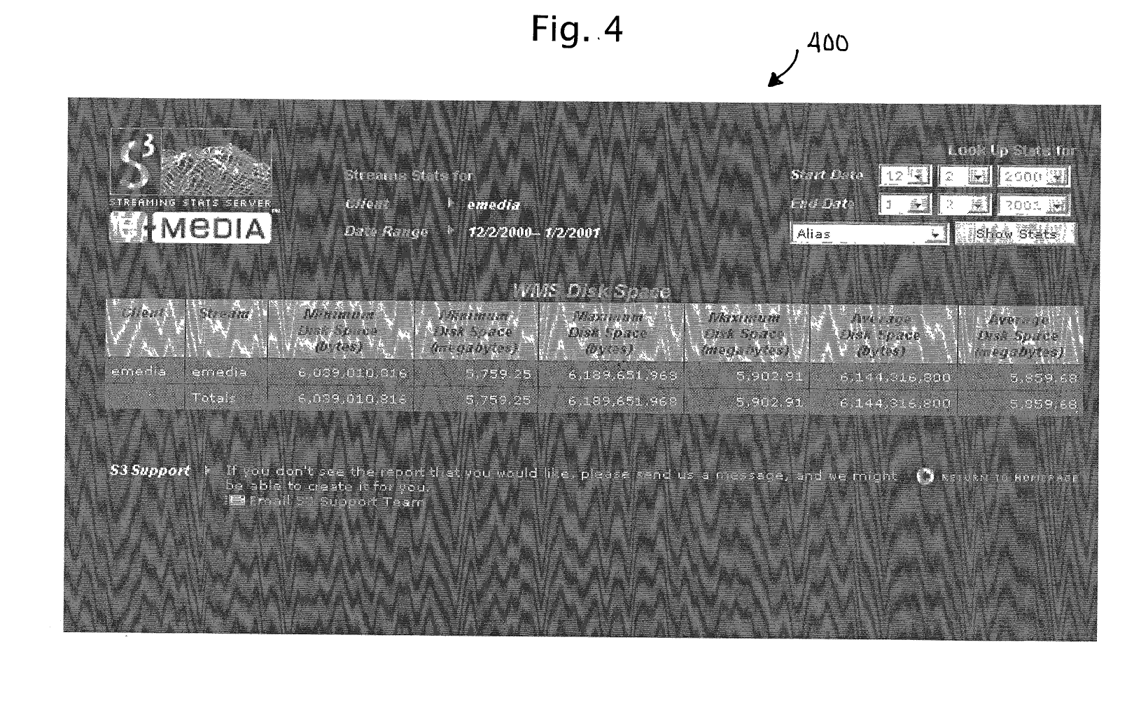

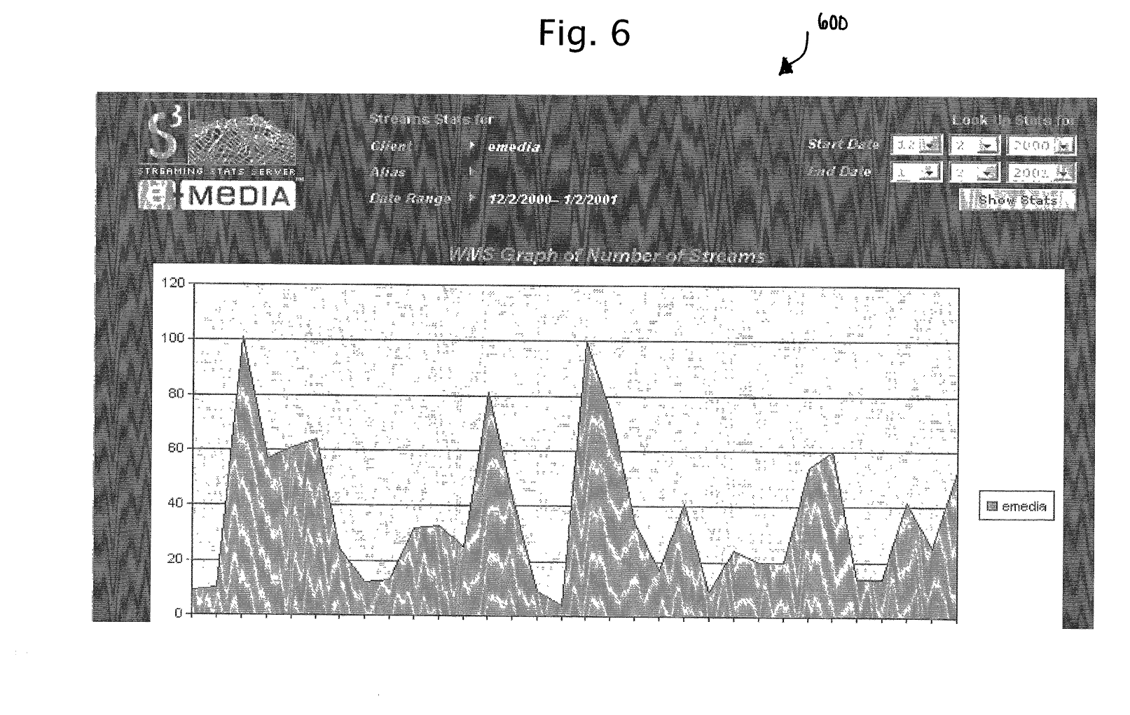

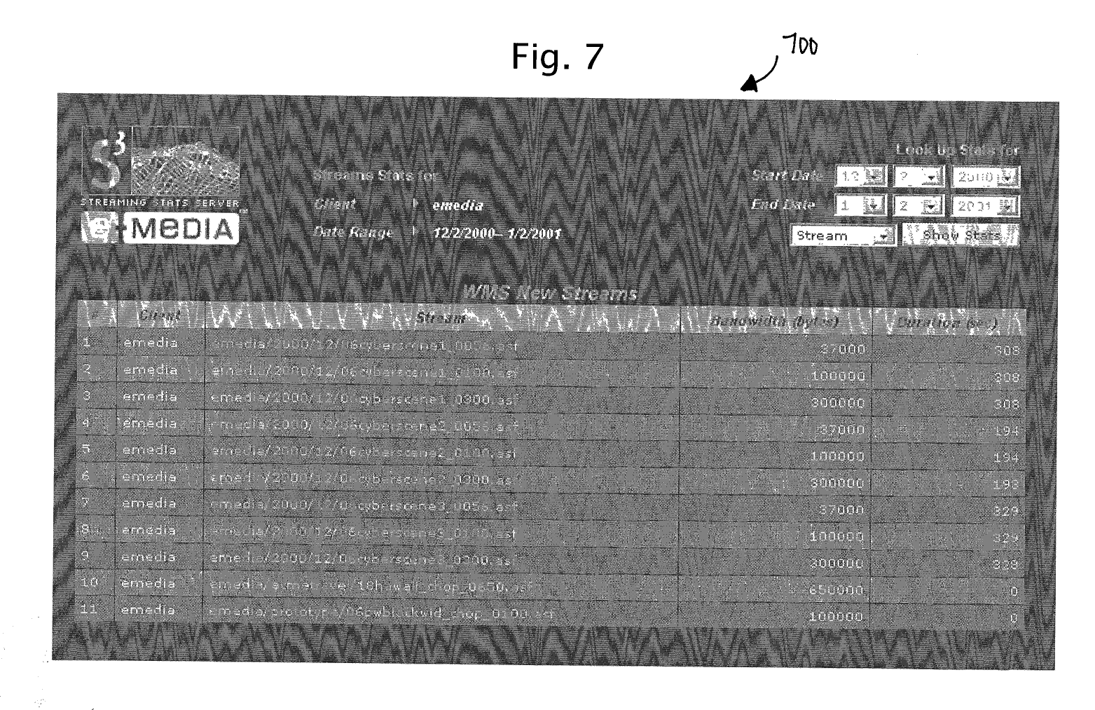

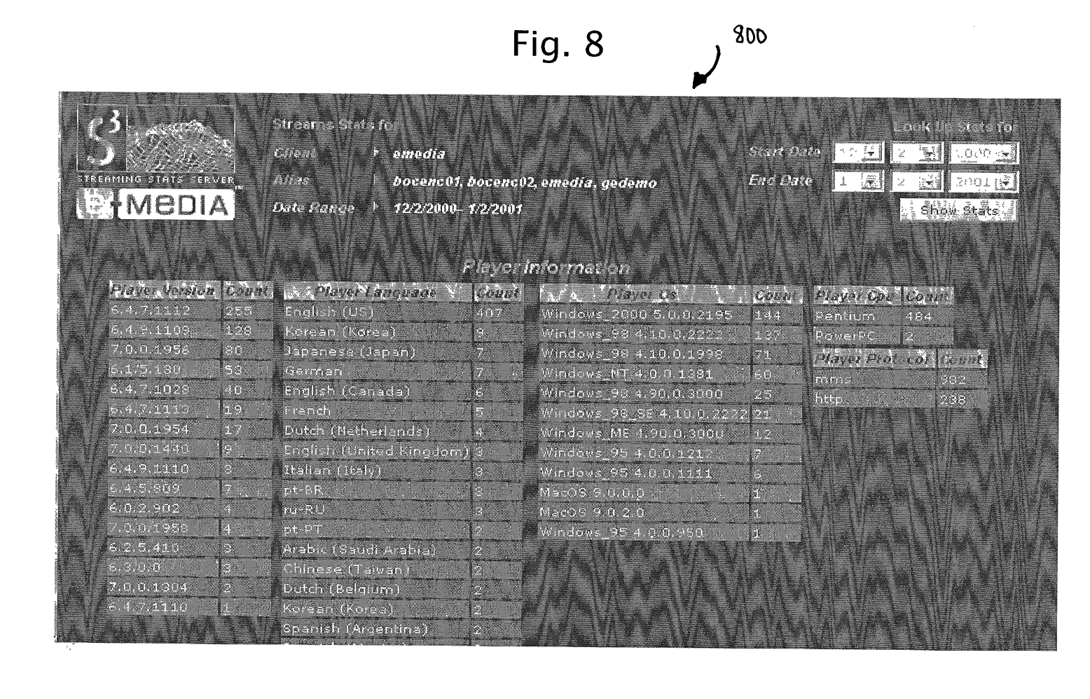

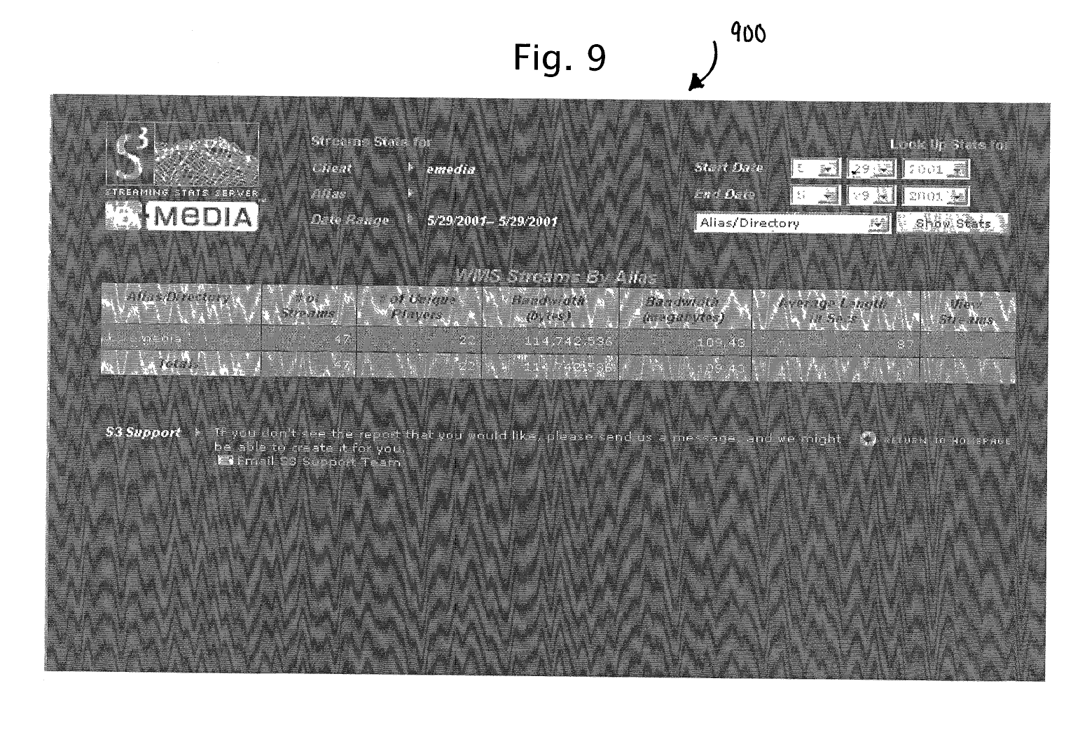

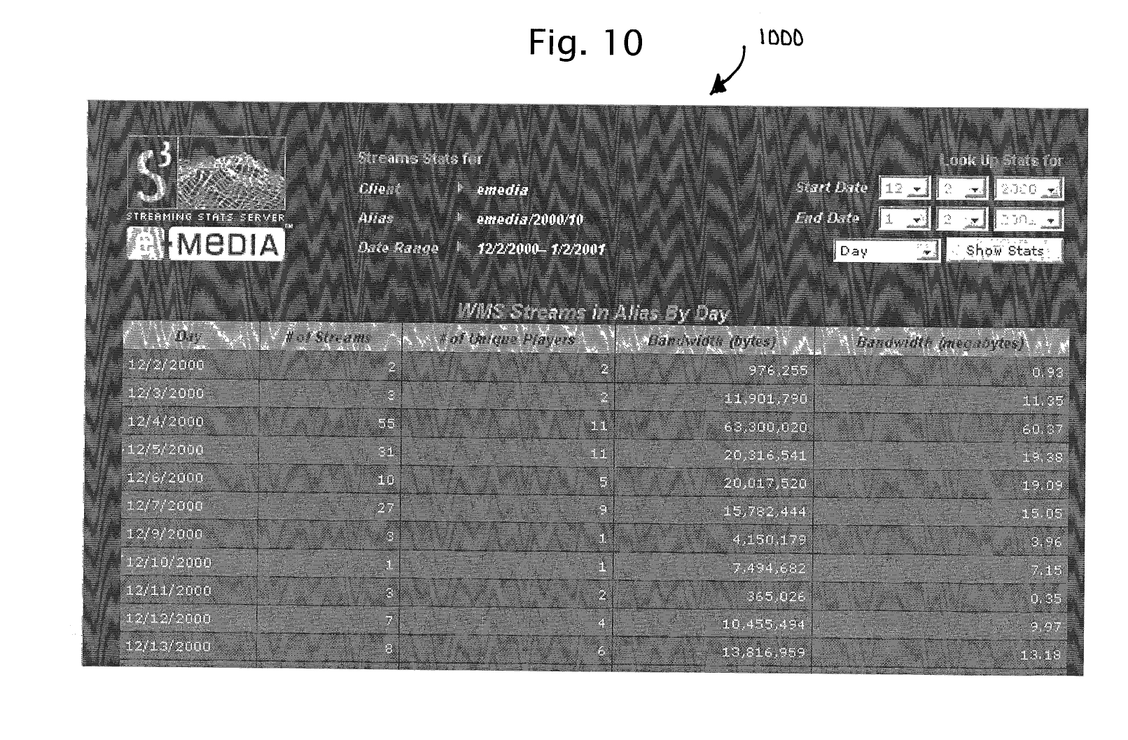

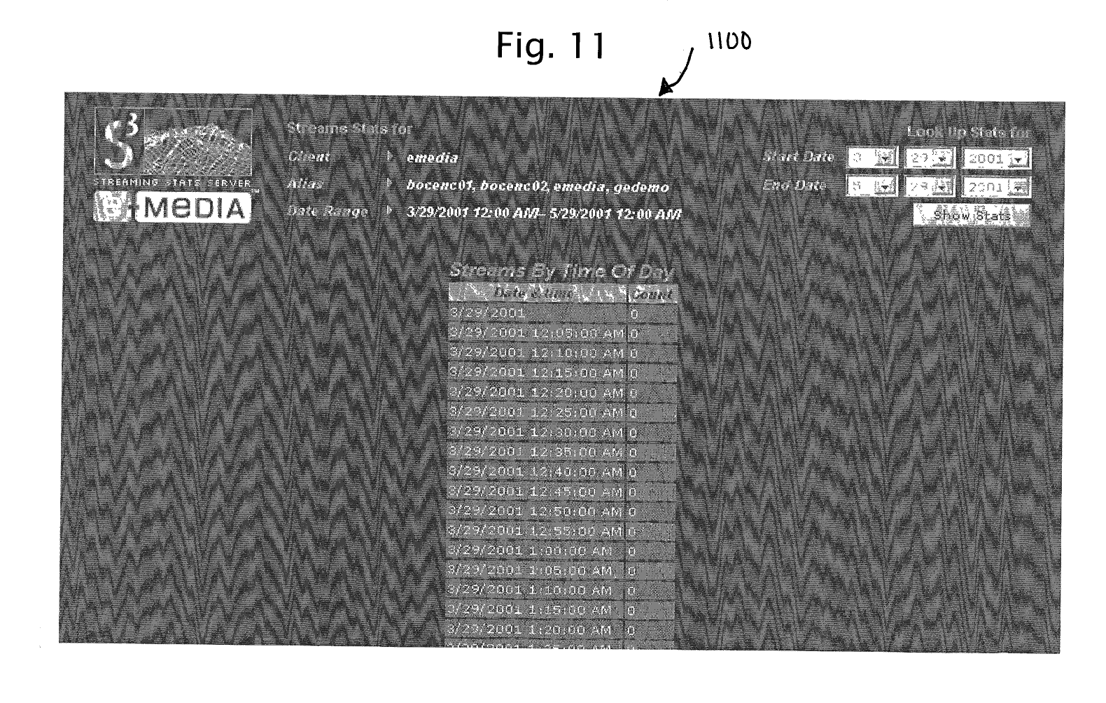

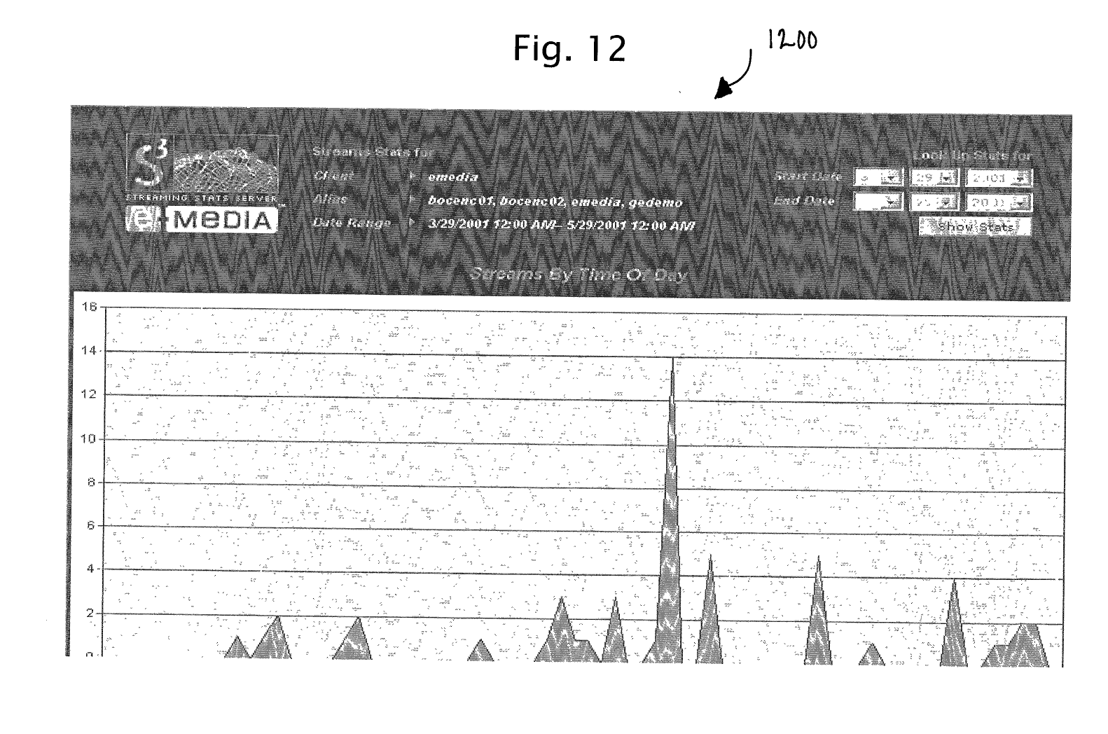

As will be readily apparent, the flexibility to create reports and analysis based on data/information contained in database 116 provides individuals/analysts with a significant reporting and analytical tool. FIGS. 4-12 depict alternative screen shots for user interfaces 400, 500, 600, 700, 800, 900, 1000, 1100 and 1200, respectively, according to the system/method of the present disclosure. In each instance, the user/analyst selects the desired date range in appropriate data entry blocks. User interfaces 400, 700, 900 and 1000 provide additional exemplary drop down menus that permit the individual/analyst to select data/information of interest. Thus, for user interface 400 in FIG. 4, the individual/analyst has selected “alias” for purposes of reporting on the WMS Disk Space, whereas for user interface 700, “stream” was selected in the drop down menu as the parsing criteria. The selected parsing criteria determines the data to be accessed in database 116 and the format of the tabular report on the user interface of the individual/analyst. In each instance, the “Show Stats” command commences the query of database 116 and results in generation of the desired tabular report.

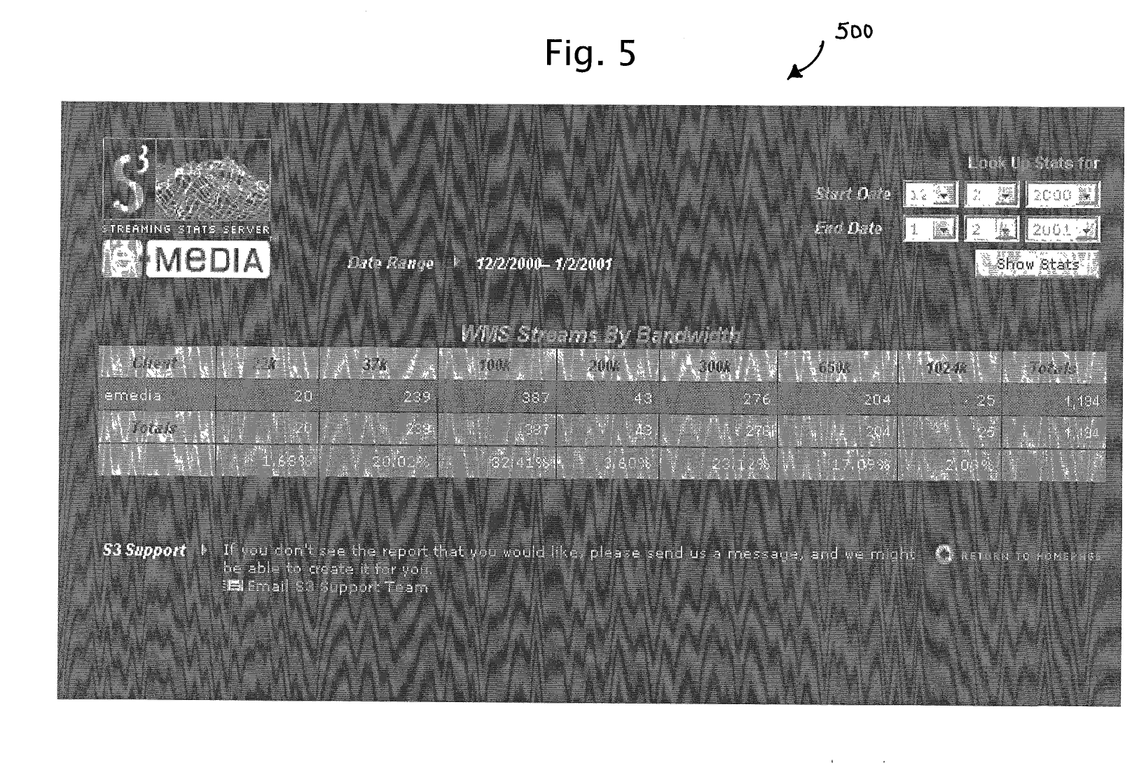

With reference to FIGS. 5, 6, 8, 11 and 12, the respective user interfaces do not provide a drop down menu. Rather, once the individual/analyst has selected the desired date range, the “Show Stats” command is the only remaining step to generate the desired tabular report based on data/information contained in database 116. Thus, for example, with reference to FIG. 2, selection of the “WMS Distribution by Bandwidth” report from among the choices in left column 204 advantageously directs an individual/analyst to a user interface as exemplified by user interface 500 in FIG. 5. Once the date range is selected, the system/method of the present disclosure accesses relevant data concerning the “emedia” WMS media files delivered, as stored in database 116 for the Dec. 2, 2000 to Jan. 2, 2001 timeframe, and generates a tabular report, as shown in FIG. 5. Similar operations and interactions are contemplated with respect to user interfaces 600, 800, 1100 and 1200.

According to preferred embodiments of the system/method of the present disclosure, several reporting features are provided that translate to specific reporting benefits. The following Table summarizes certain of these reporting features and reporting benefits.

TABLE

| REPORTING FEATURE | REPORTING BENEFIT |
|---|---|
| Summary Report | High-level information on the number streams |
| | served, the number of unique players and the |
| | preferred player format and bit rate, as well as |
| | the average length viewed |
| Total Streams | Number of total streams served with |
| | corresponding bandwidth and storage data |
| Most Popular Streams | Top 7 streams served for the time period |
| | selected. It also displays the bit rate of the |
| | stream, player format, actual connection speed |
| | and average length viewed |
| New Streams | Information on when a stream was first served |
| Streams Served by | Breaks out the total streams served by player |
| Format | format |
| Format - Detail | Detailed analysis on the number of streams |
| | served, at which bit rate and the average |
| | length viewed; broken out by player format |
| Unique Player | High level view of unique players by format |
| Bit Rate | Data on the total number of streams served, |
| | organized by the bit rate viewers selected |
| Megabytes Transferred & | Provides data on bandwidth transferred and |
| Stored | storage |
| Activity by Time | Data on number of streams served in a |
| of Day | specific time period for, on a per day basis |
| | (streams by time of day) |
| Player Analysis | Data on the number of streams served and the |
| | player versions, language, operating system |
| | and CPU |
| Visitor Requests | Number of unique visitors and total visits |
| Source & Browser Data | Provides information on where viewers came |
| | from and the browsers they use |

In sum, the system and method of the present disclosure provides a powerful, flexible and efficient tool for capturing useful media file statistics in a database and provides powerful reporting and analytic capabilities with respect to the collected media file delivery statistics. The system/method advantageously provides a searchable database from which reports may be generated from the data collected in the database. The user interface facilitates easy and rapid navigation for the media file delivery analysis and business decision-making based thereon.

Although the present disclosure includes detailed descriptions with reference to certain preferred embodiments of the disclosed system/method, the present disclosure is not to be limited thereto. Rather, the system/method of the present disclosure is subject to various modifications and variations without departing from the spirit of the disclosure or the scope of the claims which follow. For example, it is contemplated that the system/method of the present application may be advantageously integrated to read textual log files for non-media related file delivery, e.g., HTML pages and the like, and to include the data/information from delivery of such non-media files in searchable database(s). In this way, reporting and analysis may be extended to non-media file delivery, as is known in the art. These and other modifications/variations will be apparent to persons skilled in the art based on the detailed description provided herein, and are encompassed within the scope of the present disclosure.

1. A method for generating a report related to delivery of media files, comprising:
a. collecting data in a media server, said data related to delivery of said media files by said media server in textual log files in media player format;
b. transferring said textual log files containing said collected data from said media server to a statistics server on a predetermined periodic basis;
c. inputting said data from said textual log files into a database;
d. storing said data in predetermined tabular fields based on characteristics of said data; and
e. providing a user interface that allows a user to generate reports based on selected criteria displayed on said user interface, said selected criteria corresponding to said predetermined tabular fields.

2. A method for generating a report related to delivery of media files according to claim 1, wherein said media server is included within a redundant array of media servers.

3. A method for generating a report related to delivery of media files according to claim 1, wherein said textual log files includes information selected from the group consisting of an IP address of a computer making a media file request, a name of said requested file, user name, date of said request, browser type, referring Website, destination Website, media server name, media server IP address, error code, bytes received, bytes sent, time taken, and combinations thereof.

4. A method for generating a report related to delivery of media files according to claim 1, wherein said textual log files are transferred to said statistics server on a batch basis.

5. A method for generating a report related to delivery of media files according to claim 1, wherein said data is input to said database in individual directories.

6. A method for generating a report related to delivery of media files according to claim 5, wherein said individual directories correspond to individual clients utilizing said media server to deliver media files to users.

7. A method for generating a report related to delivery of media files according to claim 6, wherein said predetermined tabular fields within said database are segregated by said individual clients.

8. A method for generating a report related to delivery of media files according to claim 1, wherein said user interface is accessible to users based upon a user name and password validation process.

9. A method for generating a report related to delivery of media files according to claim 8, wherein said user name and password validation process defines multiple tiers of access clearance to data stored within said database.

10. A method for generating a report related to delivery of media files according to claim 1, wherein said user interface includes a listing of pre-designed reports.

11. A method for generating a report related to delivery of media files according to claim 10, wherein said user interface includes screen displays that permit users to define date ranges for report generation.

12. A method for generating a report related to delivery of media files according to claim 10, wherein said user interface includes screen displays that permit users to define specific data types for report generation.

13. A method for generating a report related to delivery of media files according to claim 12, wherein said specific data types are selected from the group consisting of streams, media player, server, client name, time period, bandwidth and combinations thereof.
